(19) United States
(12) Patent Application Publication
(10) Pub. No.: US 2007/0089332 A1
(43) Pub. Date: Apr. 26, 2007

(54) Method for manufacturing embroidery decorated cards

(76) Inventor: Charles H. Lee, Hacienda Heights, CA (US)

Correspondence Address: Eugene Oak, 1547 Galemont Ave., Hacienda Heights, CA, 91745, US

(21) Appl. No.: 11/251,504

(22) Filed: Oct. 17, 2005

(51) Int. Cl. G09F 1/00

(52) U.S. Cl. 40/124.06

(57) ABSTRACT

A method for manufacturing cards decorated with embroidered fabrics is provided. Various kinds of drawings are embroidered on a fabric with threads of different colors. Firstly, a paper is cut into a shape of a long rectangle which is divided into three equal sections and one of which, the first section, has a window at the center therefore and three trapezoidal wings are formed along the three edges thereof, to one end of the short side of the rectangle, opposite to the first section, is connected a distorted trapezoid along the bottom side of which one trapezoid wing is developed. The first sheet of card stock is folded into four portions. A part of the first portion of the card stock, the frame, is cut out of various shapes. The embroidered fabric is cut into a certain size and adhered to the rear side of the frame with hand. The front side of the paper frame is decorated with various kinds of paintings, pictures, phrases and emblems.

This invention relates to an economical method for manufacturing cards decorated with embroidered fabrics.

1. Field of the Invention

A method for manufacturing cards and envelopes decorated with embroidered fabrics is provided. Various kinds of embroidered fabrics are cut into certain size and patched behind a paper frame to make, including but not limited to, a seasonal greeting card, congratulatory card, a business card, an invitation card, a post card and an envelope.

2. Description of the Prior Art

U.S. Pat. No. 4,439,941 to Halperine illustrates a printed card, tag and the like with a reusable printed multicolored emblem. A multicolored embroidered emblem is releasably attached to the face of a sheet printed with a design and provided with a surface with a reduced adhesive bonding. The multicolored embroidered emblem is constructed of embroidery made of a single white thread to form a sculptured pattern. The sculptured pattern is created by varying the direction of the stitches of the embroidery thread and the number of thread stitches in various locations of the embroidered emblem. The multicolored pattern is printed on the face with at least two colors of dyestuff by a sublimation printing process, wherein the dyestuff is transferred in a vapor state under heat and pressure or vacuum. The dyestuff, which forms the printing on the embroidery threads, forms the layer.

U.S. Pat. No. 5,727,496 to McGaver teaches a method of manufacturing a greeting card. The process consists of folding a first sheet of card stock into a tri-fold configuration having first to third equal portions, cutting a window into the first portion, and bonding the first portion, the second portion, and the sheet of fabric, consecutively. A sheet of embroidery-decorated fabric is disposed between the first and second sections of card stock. A sheet of poly-ester polymer web adhesive, having a minimum heat activation temperature of 280° F. and a density 0.3 lbs per gallon, is disposed between the sheet of fabric and the second section of card stock to bond the sheet of fabric to the first and second sections of card stock, by applying heat at a temperature range of 300 to 310° F. and a pressure range of 240 to 260 lbs per square inch.

Those prior arts have very sophisticated and energy consuming procedures.

### SUMMARY OF THE INVENTION

Therefore, it is the purpose of this invention to provide a method for manufacturing cards and envelopes decorated with embroidered fabrics at a reduced cost and energy. Various kinds of drawings are embroidered on a fabric with threads of different colors. Firstly, a paper is cut into a shape of a long rectangle which is divided into three equal sections and one of which, the first section, has a window at the center therefore and three trapezoidal wings are formed along the three edges thereof, to one end of the short side of the rectangle, opposite to the first section, is connected a distorted trapezoid along the bottom side of which one trapezoid wing is developed. The first sheet of card stock is folded into four portions. A part of the first portion of the card stock is cut out of various shapes such as heart, square, and star to make a frame. The embroidered fabric is cut into certain size and adhered to the rear side of the frame, on which peel off glue is attached, without applying heat and pressure. Front side of the paper frame is decorated with, including but not limited to, various kinds of the paintings, pictures, phrases and emblems. The card of this invention may be used as, including but not limited to, a season's greeting card, congratulatory card, a business card, an invitational card, a post card, and an envelope of this invention can be used as envelope for previously recommended cards.

### BRIEF DESCRIPTION OF THE DRAWINGS

FIG. 1 is a front view of the first sheet of card stock of this invention before folding.

FIG. 2 is a rear view of the first sheet of card stock of this invention before folding.

FIG. 3 is a schematic configuration of frame layer, peel off glue, embroidery, second portion of the card stock.

FIG. 4 is an outer surface view of the card of this invention after completion.

FIG. 5 is an inner surface view of the card of this invention after completion.

### DETAILED DESCRIPTION OF THE PREFERRED EMBODIMENTS

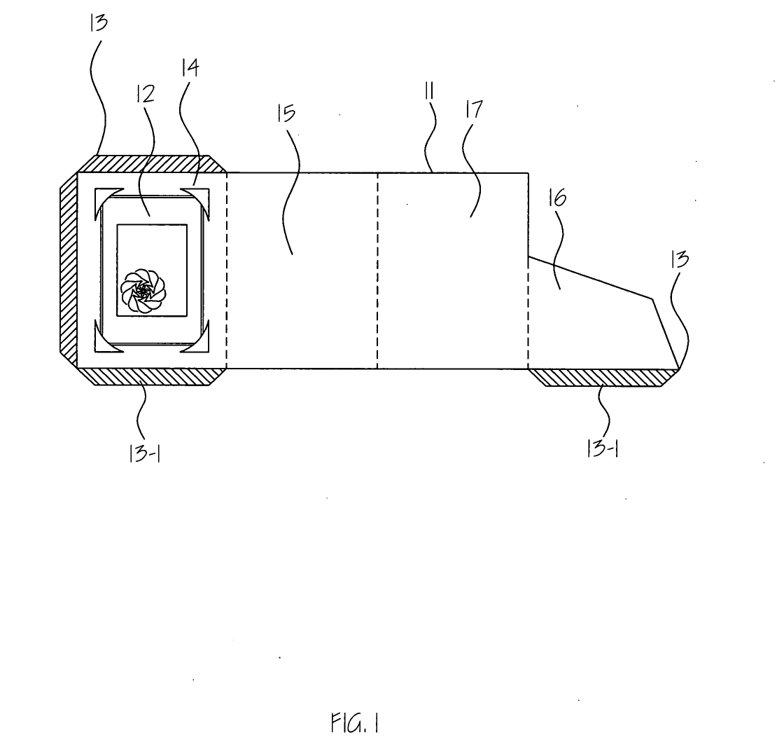

A first sheet of card stock is cut into a form shown as (11) in FIG. 1, a shape comprised of three portions of rectangular forms of a same size connected in series, the first portion of the card stock has three wings of shallow trapezoid shape, which are developed on the three edges, and one portion of distorted trapezoid form, whose maximum height is half of that of the rectangular form, connected serially to the third portion of rectangular form, having a shallow trapezoid shape, on which a peel off glue is attached. A window (12) of various shapes is punctured on the first portion (14) of the card stock (11). Peel off glue (13-1) is adhered on the faces of the three wings (13) of the first portion (14) of the card stock (11). The three wings (13) on the first portion (14) of the card stock (11) are folded backward to be bonded to the rear face of the second portion (15) of the card stock (11). One wing (13) on the fourth portion (16) of the card stock (11) is folded backward and bonded to the third portion (17) of the card stock (11) by the peel off glue (13-1) on that wing. Lower border lengths of the first three portions are the same. The border length of the forth portion (16) of the card (11) is a little bit shorter.

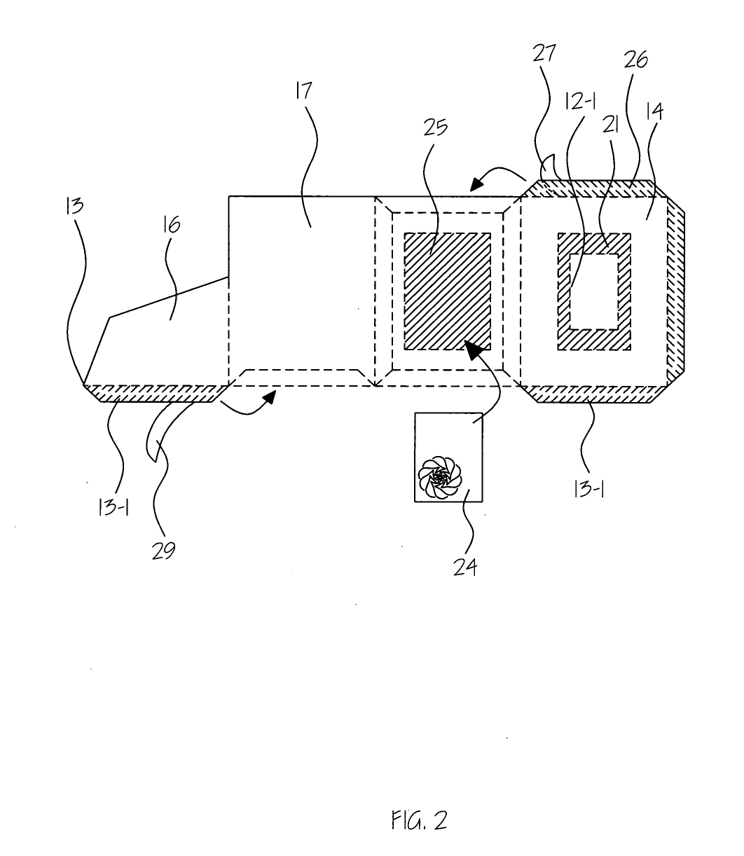

FIG. 2 is the rear view of the card stock (11). Peel off glue (21) having window (12-1) in the center is adhered on the rear face surrounding the window (12) punctured on the first portion (14) of the card stock (11). Embroidery decorated fabric (24), cut into certain size, is positioned after the film, protecting the glue on the place mark (25), is peeled off. The wings (13) on the first portion (14) of the card stock (11), on which the peel off glues (13-1) are adhered, are folded inwards. The peels (27) are removed and the wing is bonded on to the front face of the second portion (15) of the card stock (11). At the same time, the peel (29) on the wing (13) of the fourth portion (16) of the card stock (11) is removed and the wing (13) is bonded to the third portion (17) of the card stock (11).

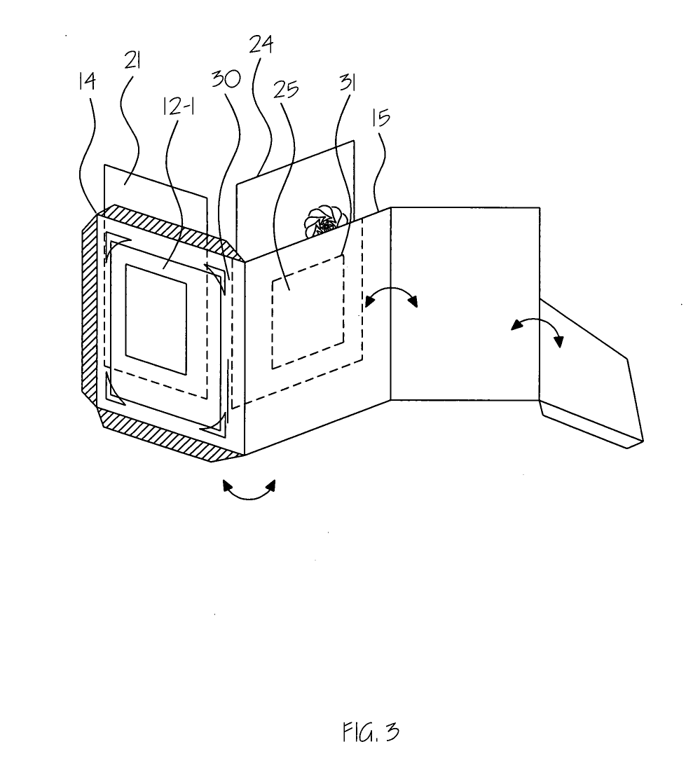

FIG. 3 is a schematic configuration of first portion (14) of the card stock (11), peel off glue (21), embroidery decorated fabric (24), and the second portion (15) of the card stock (11). Peel off glue (21) having another window (12-1) in the middle is attached at the rear face (30) of the first portion (14) of the card stock (11). Embroidery decorated fabric (24) locates on the mark place (25) over which a peel off glue (31) is attached. The first portion (14) of the card stock (11) is folded over the second portion (15) of the card stock (11).

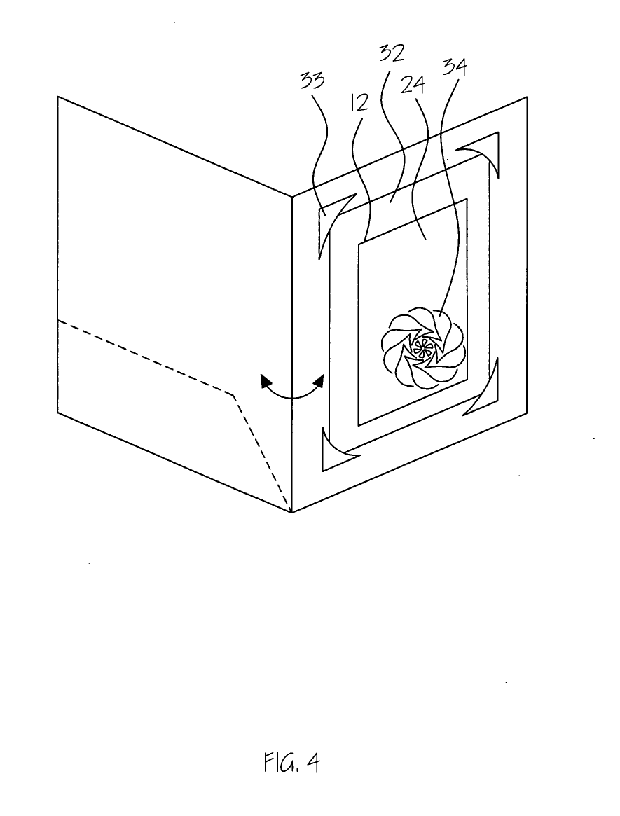

Slight pressing the folded card stock with hand results a card as FIG. 4. The front face of the greeting card has a window (12) of various shapes such as square, heart and star. The frame (32) of the front face of the first part (14) of the card stock (11) is decorated with, including but not limited to, a printing, embroidery, phrases and embossing (33). Behind the first part (14) of the card stock (11), locates an embroidery decorated fabric (24) consisting of, including but not limited to, a velvet, cotton, polyester, nylon and wool. The fabric (24) is decorated with embroidery (34) of various designs. Using threads of different colors controls the color of the embroidery.

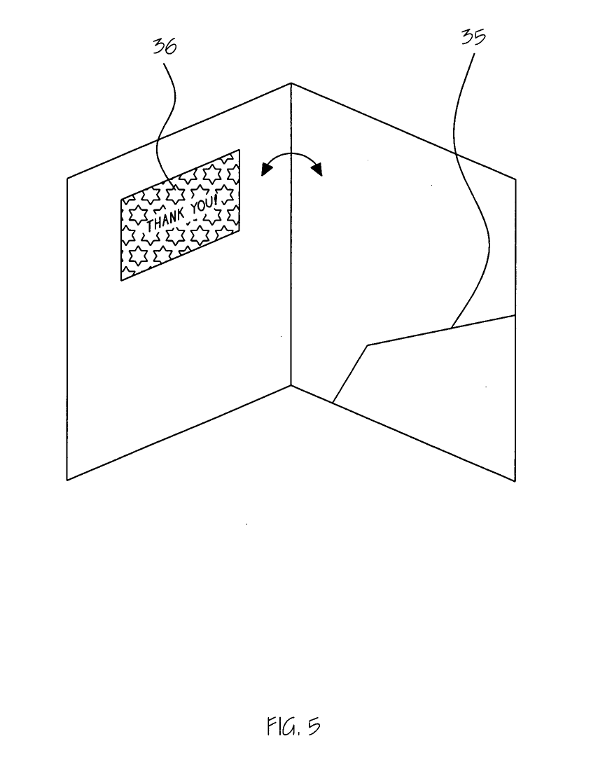

FIG. 5 is an inner surface view of the card of this invention after completion. The small fourth part (16) of the card stock of the FIG. 1, becomes pocket (35) for some messages, if desired. Greeting messages (36) can be printed on the rear side of the second part (15) of the card stock (11). Application of the method to the other items such as envelope, post card and other similar items are easily imaginable based on the current application.

What is claimed is:

1. A method for manufacturing an embroidery decorated card with:
1) a card stock, which is cut into a shape comprised of three portions of rectangular forms of a same size connected in series, a first portion of the card stock has a window punctured at a center and has three wings of shallow trapezoid shape, which are developed along the three edges, and one portion of distorted trapezoid form, connected serially to a third portion of the rectangular forms, having a shallow trapezoid shape wing; and
2) an embroidery, made with various threads of different colors and decorated fabric; and
3) six pieces of peel off gules, three of them are attached on the three wings of the first portion of the card stock and the other three are attached on the wing of the distorted trapezoid portion, behind the window of the first portion of the card stock, and inside of the second portion of the card stock respectively, by following steps of;
a) fold the three wings on the first portion of the card stock, backward to let the three wings face the rear face of a second portion of the card stock, and
b) fold the wing, which is developed on the distorted trapezoid formed portion, backward to let the wing surface, on which glue is pasted, adheres to the third portion of the card stock, and
c) adhere a peel off glue, having a window at a center matching to the window on the first portion of the card stock, to the rear face of the first portion of the card stock, and
d) adhere another peel off glue to the second portion of the card stock, and
e) take off a peel from the peel off glues, and
f) place the embroidery, facing the window on the first portion of the card stock, on the glue on the second portion of the card stock, and
g) fold the first portion and the second portion of the card stock to face each other, and fold the third and the distorted trapezoid portions of the card stock to face each other, and
h) slightly press the card, finally formed in step g), with hands.
